(19) United States
(12) Patent Application Publication
(10) Pub. No.: US 2025/0238036 A1
(43) Pub. Date: Jul. 24, 2025

(54) AIRCRAFT LANDING GUIDANCE SYSTEM

(71) Applicant: OWLYNK CO., LTD., Suwon-si (KR)

(72) Inventor: Shin Hwan HWANG, Yongin-si (KR)

(73) Assignee: OWLYNK CO., LTD., Suwon-si (KR)

(21) Appl. No.: 18/898,691

(22) Filed: Sep. 27, 2024

(30) Foreign Application Priority Data
Jan. 18, 2024 (KR) 10-2024-0007941

(51) Int. Cl. G05D 1/654; G01S 13/46; G05D 109/20; G05D 111/30

(52) U.S. Cl. CPC G05D 1/654; G01S 13/46; G01S 2013/468; G05D 2109/20; G05D 2111/30

(57) ABSTRACT

Provided is an aircraft landing guidance system including two transmitters that are disposed on a landing pad and transmit a first frequency signal and a second radio frequency signal continuously and a receiving unit that is provided on an aircraft and includes a first receiver receiving the first radio frequency signal and a second receiver receiving the second radio frequency signal, in which the aircraft is guided and controlled to land at a point of interest based on a relative angular position change and relative speed of the landing pad.

### CROSS-REFERENCE TO RELATED APPLICATION(S)

This application claims priority from Korean Patent Application No. 10-2024-0007941, filed on Jan. 18, 2024, in the Korean Intellectual Property Office, the disclosure of which is incorporated herein by reference in its entirety.

### BACKGROUND

### 1. Field

The following description relates to a system technology for guiding the landing of an aircraft.

### 2. Description of Related Art

A technology for allowing an aircraft to safely and accurately take off and land on a landing pad is being developed. Korean Laid-Open Patent Publication No. 10-2024-0002998 (Title: “Takeoff and landing control system of aircraft using phase difference of RF signal”), filed on Jun. 29, 2022 and published on Jan. 8, 2024, discloses a technology for controlling the takeoff and landing of an aircraft by more precisely calculating an altitude of the aircraft using a phase difference between two radio frequency (RF) signals rather than calculating the altitude of the aircraft using a global positioning system (GPS).

However, when a takeoff and landing pad, such as a takeoff and landing pad provided on a moving vehicle, a moving aircraft carrier or warship, or an aircraft in flight moves with a complex movement (when taking off or landing on a moving vehicle), or has a complex motion (when taking off or landing on a moving ship), a point of interest (landing point) of the takeoff and landing pad shows a complex movement having a translation of t and a rotation of 0. In this case, methods using the existing GPS, an altimeter, or a general position estimation technique cannot estimate the movement of the landing point, making safe and accurate landing impossible.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The following description relates to a technology for safely and accurately landing an aircraft at a point of interest on a two-dimensionally moving landing pad.

Furthermore, the following description relates to a technology for safely and accurately landing an aircraft at a point of interest on a three-dimensionally moving landing pad

In one general aspect, there is provided an aircraft landing guidance system including two transmitters that are disposed on a landing pad and transmit a first frequency signal and a second radio frequency signal continuously and a receiving unit that is provided on an aircraft and includes a first receiver receiving the first radio frequency signal and a second receiver receiving the second radio frequency signal, in which the aircraft is guided and controlled to land at a point of interest based on a relative angular position change and relative speed of the landing pad.

In another general aspect, there is provided an aircraft landing guidance system including three transmitters that are disposed on a landing pad and transmit a first frequency signal, a second radio frequency signal, and a third radio frequency signal continuously and a receiving unit that is provided on an aircraft and includes a first receiver receiving the first radio frequency signal, a second receiver receiving the second radio frequency signal, and a third receiver receiving the third radio frequency signal, in which the aircraft is guided and controlled to land at a point of interest based on a relative angular position change and relative speed of the landing pad.

Other features and aspects will be apparent from the following detailed description, the drawings, and the claims.

### BRIEF DESCRIPTION OF THE DRAWINGS

FIG. 1 is a diagram illustrating an aircraft landing guidance system according to an embodiment.

FIG. 2 is a block diagram illustrating a transmitting unit according to an embodiment.

FIG. 3 is a block diagram illustrating a configuration of an aircraft according to an embodiment.

FIG. 4 is a diagram illustrating a system for guiding an aircraft to land on a landing pad that is translated two-dimensionally in accordance with an embodiment.

FIG. 5 is a diagram illustrating a system for guiding an aircraft to land on a landing pad that is rotated two-dimensionally in accordance with an embodiment.

FIG. 6 is a diagram illustrating an aircraft landing guidance system according to another embodiment.

FIG. 7 is a block diagram illustrating a transmitting unit according to another embodiment.

FIG. 8 is a block diagram illustrating a configuration of an aircraft according to another embodiment.

FIG. 9 is a diagram illustrating a system for guiding an aircraft to land on a landing pad that is rotated three-dimensionally in accordance with another embodiment.

FIG. 10 is a diagram illustrating a system for guiding an aircraft to land on a landing pad that is rotated three-dimensionally in accordance with another embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The aforementioned and additional aspects are embodied through embodiments described with reference to the accompanying drawings. It is understood that components of embodiments may be combined in various ways within an embodiment or with components of other embodiments, as long as there is no other mention or conflict between the components. Based on the principle that an inventor may appropriately define the concept of terms to describe his or her invention in the best way, the terms used in this specification and claims should be interpreted to have meanings and concepts that are consistent with the contents described or the technical ideas proposed. Hereinafter, an exemplary embodiment of the present invention will be described in detail with reference to the accompanying drawings.

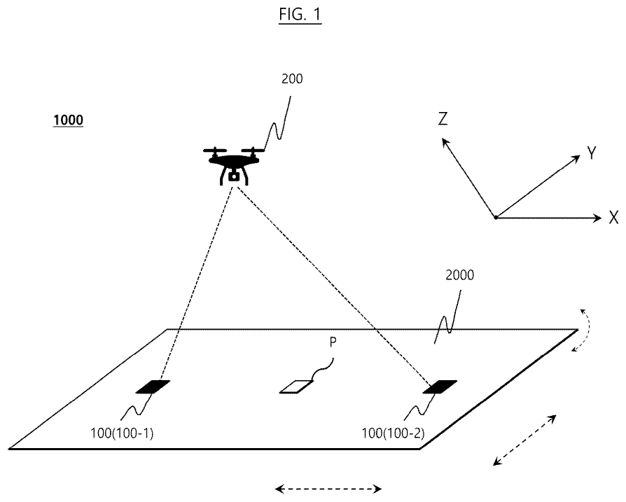

FIG. 1 is a diagram illustrating an aircraft landing guidance system according to an embodiment. As illustrated, an aircraft landing guidance system 1000 may include a transmitting unit 100 and an aircraft 200. The aircraft landing guidance system 1000 may be a system for landing an aircraft at a point of interest on a two-dimensionally moving landing pad. The aircraft landing guidance system 1000 does not include a landing pad 2000. The landing pad 2000 may be provided with a point of interest P where the aircraft 200 intends to land. The point of interest P may be any location relatively fixed to the transmitting unit 100.

The aircraft 200 needs to land at the point of interest P in the correct attitude.

What is meant by the landing pad moving two-dimensionally may mean that the landing pad is translated or rotated on the XY plane. The power source that causes the landing pad to move may be provided in an object itself having the landing pad, but may also be an external environment such as wind, buoyancy, or terrain.

The aircraft landing guidance system 1000 of FIG. 1 does not exclude a landing pad 2000 that moves three-dimensionally. It is sufficient that the landing pad 2000 can move two-dimensionally.

The transmitting unit 100 may be disposed in the landing pad 2000 and continuously transmit a radio frequency signal Tx.

The aircraft 200 may receive the radio frequency signal. The aircraft may include a drone, a helicopter, or an airplane, and may include a device that can fly by power in the air. The aircraft 200 is provided with a propeller or wings, and the moving speed, moving direction, or landing attitude thereof may be adjusted through power control. The aircraft 200 may monitor the movement of the landing pad 2000 while tracking changes in an angular position of the landing pad 2000 while floating in the air.

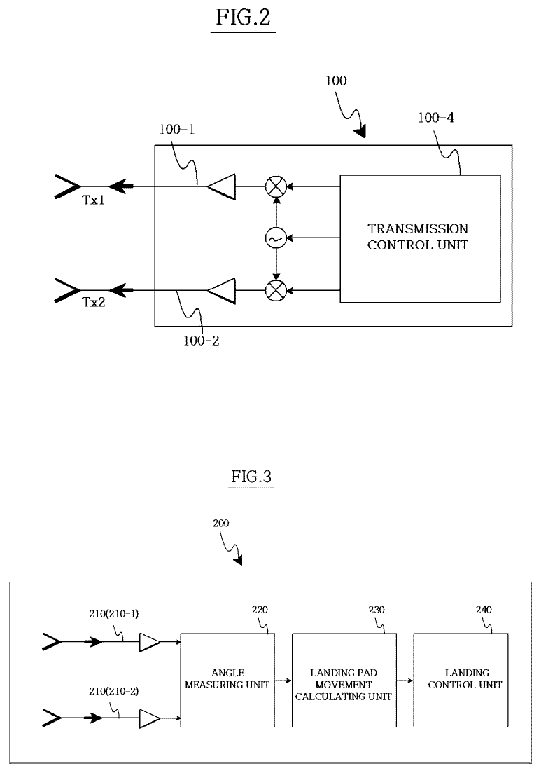

FIG. 2 is a block diagram illustrating a transmitter according to an embodiment. As illustrated, the transmitting unit 100 may include a first transmitter 100-1 and a second transmitter 100-2.

The first transmitter 100-1 may continuously transmit a first radio frequency signal Tx1.

The second transmitter 100-2 may be disposed to be spaced apart from the first transmitter 100-1 and may continuously transmit a second radio frequency signal Tx2.

According to an embodiment, the first transmitter 100-1 and the second transmitter 100-2 may be disposed in an edge area of the landing pad 2000, and a point of interest p may be disposed between the first transmitter 100-1 and the second transmitter 100-2. The first transmitter 100-1 and the second transmitter 100-2 may include an antenna.

The first radio frequency signal Tx1 and the second radio frequency signal Tx2 may have the same frequency, but preferably may have different frequencies.

According to an embodiment, the transmitting unit 100 may include a transmission control unit 100-4, and the transmission control unit 100-4 may control the first radio frequency signal Tx1 and the second radio frequency signal Tx2 to be transmitted simultaneously.

The first radio frequency signal Tx1 and the second radio frequency signal Tx2 may be encoded in the transmitting unit 100 and decoded in the aircraft 200.

Each of the first transmitter 100-1 and the second transmitter 100-2 may include multiple antennas and may emit multiple radio frequencies at a wide range of elevation angles and azimuth angles.

FIG. 3 is a block diagram illustrating a configuration of an aircraft according to an embodiment. As illustrated, the aircraft 200 may include a receiving unit 210, an angle measuring unit 220, a landing pad movement calculating unit 230, and a landing control unit 240.

The receiving unit 210 may include a first receiver 210-1 that receives the first radio frequency signal Tx1 and a second receiver 210-2 that receives the second radio frequency signal Tx2.

The angle measuring unit 220 may measure a first angle that changes continuously over time between a transmission direction of the first radio frequency signal and a landing surface and a second angle that changes continuously over time between a transmission direction of the second radio frequency signal and the landing surface, based on the transmission directions of the first radio frequency signal and the second radio frequency signal.

Each of the first angle and the second angle may include a set of multiple angles having different values.

The transmission direction may mean a direction in which the first radio frequency signal Tx1 and the second radio frequency signal Tx2 are transmitted based on a position of the receiving unit 210.

The landing pad movement calculating unit 230 may calculate a relative angular position change and relative speed of the landing pad based on the first angle and the second angle. The relative angular position change and relative speed of the landing pad may be calculated as the relative angular position change and the relative speed of the landing pad 2000 over time that is calculated based on the aircraft 200.

The landing control unit 240 may control the aircraft 200 to land at the point of interest based on the relative angular position change and relative speed of the landing pad.

The landing control unit 240 may control a power source (e.g., motor) and/or direction control unit of the aircraft 200 based on the relative angular position change and relative speed of the landing pad to adjust the moving speed, moving direction, or landing attitude of the aircraft 200.

According to an embodiment, the aircraft 200 may further include a storage unit (not illustrated) that stores data related to the relative angular position and relative speed.

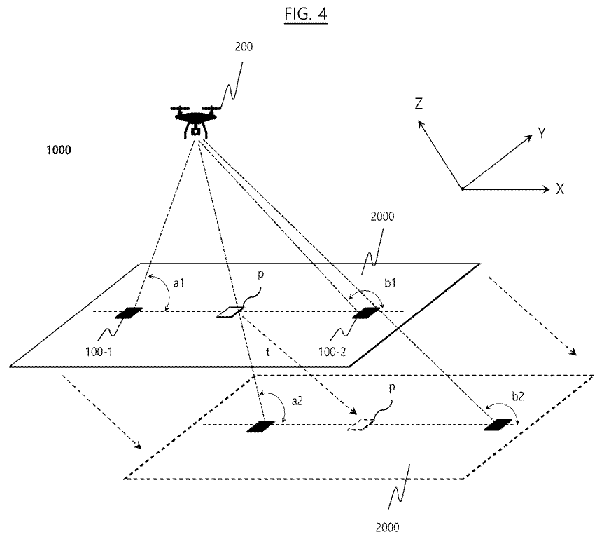

FIG. 4 is a diagram illustrating a system for guiding an aircraft to land on a landing pad that is two-dimensionally translated according to an embodiment. As illustrated, the landing pad 2000 is translated on the XY plane, and the point of interest P is translated by t. As a result, the directions in which the first radio frequency signal Tx1 and the second radio frequency signal Tx2 are transmitted are changed based on the position of the receiving unit 210 of the aircraft 200.

The angle measuring unit 220 of FIG. 3 may (continuously) calculate first angles a1 and a2 that change continuously over time between the transmission direction of the first radio frequency signal and the landing surface and second angles b1 and b2 that change continuously over time between the transmission direction of the second radio frequency signal and the landing surface.

In addition, the landing pad movement calculating unit 230 of FIG. 3 may calculate the relative angular position change and relative speed of the landing pad based on the first angles a1 and a2 and the second angles b1 and b2.

In addition, the landing control unit 240 may control the aircraft 200 to land on the point of interest P based on the relative angular position change and relative speed of the landing pad.

According to an embodiment, the first transmitter 100-1, the second transmitter 100-2, and the point of interest P may be disposed on the same line L.

According to another embodiment, the first transmitter 100-1, the second transmitter 100-2, and the point of interest P may not be disposed on the same line L.

According to an embodiment, the first transmitter 100-1 and the second transmitter 100-2 may perform a function for calculating the movement of the landing pad 2000 on the XY plane, i.e., X-axis and Y-axis movement.

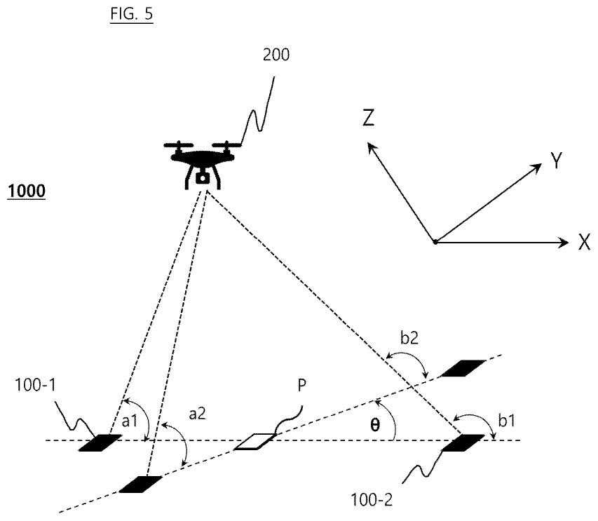

FIG. 5 is a diagram illustrating a system for guiding a landing aircraft to land on a landing pad that rotates two-dimensionally according to an embodiment. As illustrated, the landing pad 2000 is rotated on the XY plane. As a result, the direction in which the first radio frequency signal Tx1 and the second radio frequency signal Tx2 are transmitted is changed based on the position of the receiving unit 210 of the aircraft 200.

Referring to FIG. 3, the angle measuring unit 220 may (continuously) calculate first angles a1 and a2 that change continuously over time between the transmission direction of the first radio frequency signal and the landing surface and second angles b1 and b2 that change continuously over time between the transmission direction of the second radio frequency signal and the landing surface.

In addition, the landing pad movement calculating unit 230 may calculate the relative angular position change and relative speed of the landing pad based on the first angles a1 and a2 and the second angles b1 and b2.

In addition, the landing control unit 240 may control the aircraft 200 to land on the point of interest P based on the relative angular position change and relative speed of the landing pad.

As a result, the aircraft 200 may land or settle in the attitude required by the point of interest P.

As described above, the aircraft landing guidance system 1000 according to an exemplary embodiment of the present invention may accurately and safely land the aircraft on the point of interest P by estimating two-dimensional rotation parameters (θx, θy) and translation parameters (tx, ty) based on four angle measurement values a1, b1, a2, and b2.

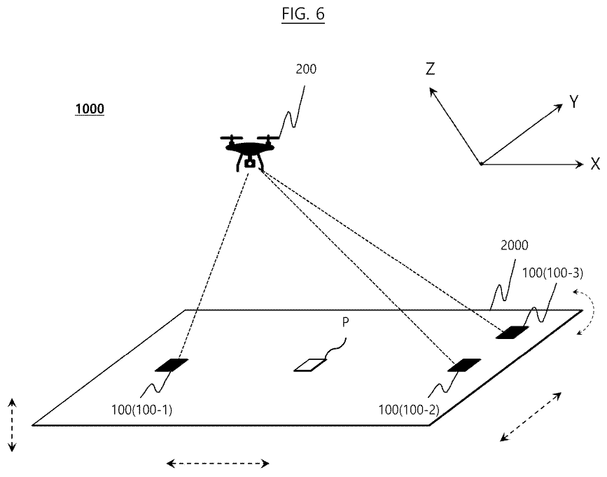

FIG. 6 is a diagram illustrating an aircraft landing guidance system according to another embodiment. As illustrated, an aircraft landing guidance system 1000 may include a transmitting unit 100 and an aircraft 200. The aircraft landing guidance system 1000 may be a system for landing an aircraft at a point of interest on a three- dimensionally moving landing pad. The aircraft landing guidance system 1000 does not include a landing pad 2000. The landing pad 2000 may be provided with a point of interest P where the aircraft 200 intends to land. The point of interest P may be any location relatively fixed to the transmitting unit 100.

The aircraft 200 needs to land at the point of interest P in the correct attitude.

What is meant by the landing pad moving three-dimensionally may mean that the landing pad is translated or rotated on the XYZ plane. The power source that causes the landing pad to move may be provided in an object itself having the landing pad, but may also be an external environment such as wind, buoyancy, or terrain.

The transmitting unit 100 may be disposed in the landing pad 2000 and may continuously transmit a radio frequency signal.

The aircraft 200 may receive the radio frequency signal. The aircraft may include a drone, a helicopter, or an airplane, and may include a device that can fly by power in the air. The aircraft 200 is provided with a propeller or wings, and the moving speed, moving direction, or landing attitude thereof may be adjusted through power control. The aircraft 200 may monitor the movement of the landing pad 2000 while tracking changes in an angular position of the landing pad 2000 while floating in the air.

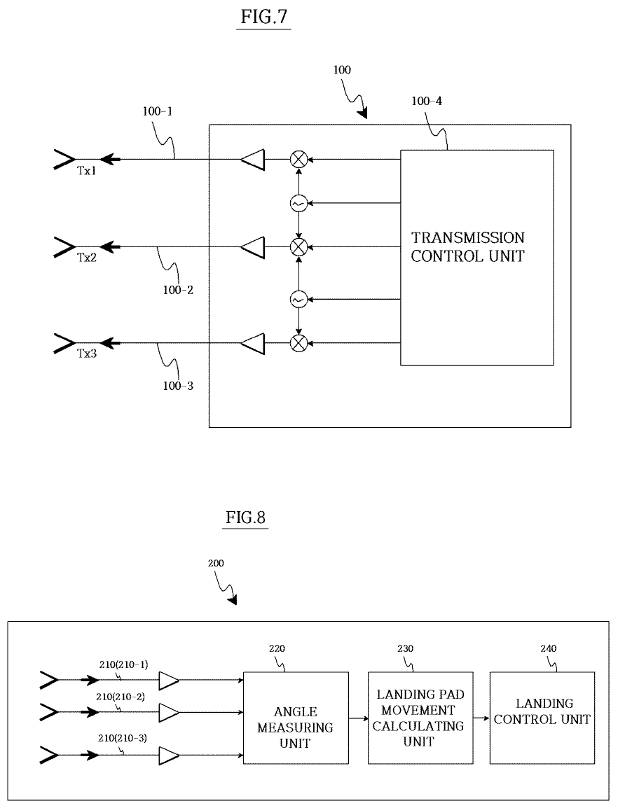

FIG. 7 is a block diagram illustrating a transmitter according to another embodiment. As illustrated, the transmitting unit 100 may include a first transmitter 100- 1, a second transmitter 100-2, and a third transmitter 100-3.

The first transmitter 100-1 may continuously transmit a first radio frequency signal Tx1.

The second transmitter 100-2 may be disposed to be spaced apart from the first transmitter 100-1 and may continuously transmit a second radio frequency signal Tx2.

The third transmitter 100-3 may be disposed to be spaced apart from the first transmitter 100-1 and the second transmitter 100-2 and may continuously transmit a third radio frequency signal.

According to an embodiment, the first transmitter 100-1, the second transmitter 100-2, and the third transmitter 100-3 may be disposed in an edge area of the landing pad 2000, and a point of interest P may be disposed between the first transmitter 100-1, the second transmitter 100-2, and the third transmitter 100-3. The first transmitter 100-1, the second transmitter 100-2, and the third transmitter 100-3 may include an antenna and may be disposed so as to form a triangle on the landing pad 2000.

The first radio frequency signal Tx1, the second radio frequency signal Tx2, and the third radio frequency signal Tx3 may have the same frequency, but preferably may have different frequencies.

According to an embodiment, the transmitting unit 100 may further include a transmission control unit 100-4, and the transmission control unit 100-4 may control the first radio frequency signal Tx1, the second radio frequency signal Tx2, and the third radio frequency signal Tx3 to be transmitted simultaneously.

The first radio frequency signal Tx1, the second radio frequency signal Tx2, and the third radio frequency signal Tx3 may be encoded in the transmitting unit 100 and decoded in the aircraft 200.

Each of the first transmitter 100-1, the second transmitter 100-2, and the third transmitter 100-3 may include multiple antennas and may emit multiple radio frequencies at a wide range of elevation angles and azimuth angles.

FIG. 8 is a block diagram illustrating a configuration of an aircraft according to another embodiment. As illustrated, the aircraft 200 may include a receiving unit 210, an angle measuring unit 220, a landing pad movement calculating unit 230, and a landing control unit 240.

The receiving unit 210 may include a first receiver 210-1 that receives the first radio frequency signal Tx1, a second receiver 210-2 that receives the second radio frequency signal Tx2, and a third receiver 210-2 that receives the third radio frequency signal Tx3.

The angle measuring unit 220 may measure a first angle that changes continuously over time between a transmission direction of the first radio frequency signal and a landing surface, a second angle that changes continuously over time between a transmission direction of the second radio frequency signal and the landing surface, and a third angle that changes continuously over time between a transmission direction of the third radio frequency signal and the landing surface, based on the transmission directions of the first radio frequency signal, the second radio frequency signal, and the third radio frequency signal.

Each of the first angle, the second angle, and the third angle may include a set of multiple angles having different values.

The transmission directions may mean directions in which the first radio frequency signal Tx1, the second radio frequency signal Tx2, and the third radio frequency signal Tx3 are transmitted based on a position of the receiving unit 210.

The landing pad movement calculating unit 230 may calculate a relative angular position change and relative speed of the landing pad based on the first angle, the second angle, and the third angle. The relative angular position change and relative speed of the landing pad may be calculated as the relative angular position change and the relative speed of the landing pad 2000 over time that is calculated based on the aircraft 200.

The landing control unit 240 may control the aircraft 200 to land at the point of interest based on the relative angular position change and relative speed of the landing pad.

The landing control unit 240 may control a power source (e.g., motor) and/or direction control unit of the aircraft 200 based on the relative angular position change and relative speed of the landing pad to adjust the moving speed, moving direction, or landing attitude of the aircraft 200.

According to an embodiment, the aircraft 200 may further include a storage unit (not illustrated) that stores data related to the angular position and relative speed.

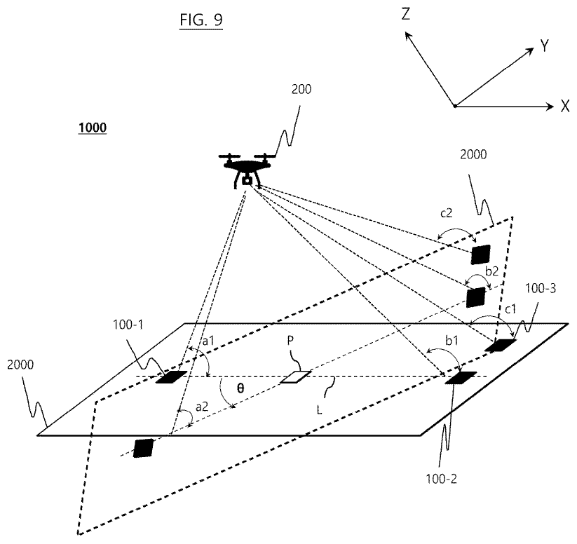

FIG. 9 is a diagram illustrating a system for guiding an aircraft to land on a landing pad that is three-dimensionally rotated according to another embodiment. As illustrated, the landing pad 2000 in rotated in XYZ space. As a result, the directions in which the first radio frequency signal Tx1 and the second radio frequency signal Tx2 are transmitted are changed based on the position of the receiving unit 210 of the aircraft 200.

Referring to FIG. 8, the angle measuring unit 220 may (continuously) calculate first angles a1 and a2 that change continuously over time between the transmission direction of the first radio frequency signal and the landing surface, second angles b1 and b2 that change continuously over time between the transmission direction of the second radio frequency signal and the landing surface, and third angles c1 and c2 that change continuously over time between the transmission direction of the third radio frequency signal and the landing surface.

In addition, the landing pad movement calculating unit 230 may calculate the relative angular position change and relative speed of the landing pad based on the first angles a1 and a2, the second angles b1 and b2, and the third angles c1 and c2.

In addition, the landing control unit 240 may control the aircraft 200 to land on the point of interest P based on the relative angular position change and relative speed of the landing pad.

As a result, the aircraft 200 may land or settle in the attitude required by the point of interest P.

As described above, the aircraft landing guidance system 1000 of an exemplary embodiment of the present invention may accurately and safely land the aircraft on the point of interest P by estimating three-dimensional rotation parameters (θx, θy, θz) and translation parameters (tx, ty, tz) based on six angle measurement values a1, b1, a2, b2, c1, and c2.

According to an embodiment, the first transmitter 100-1, the second transmitter 100-2, and the point of interest P may be disposed on the same line L. The third transmitter 100-3 may not be disposed on the same line L.

According to an embodiment, the first transmitter 100-1 and the second transmitter 100-2 may perform a function for calculating the movement of the landing pad 2000 on the XY plane, i.e., X-axis and Y-axis movement, and the third transmitter 100-3 may perform a function for calculating the Z-axis movement of the landing pad 2000.

According to another embodiment, the first transmitter 100-1, the second transmitter 100-2, and the point of interest P may not be disposed on the same line L.

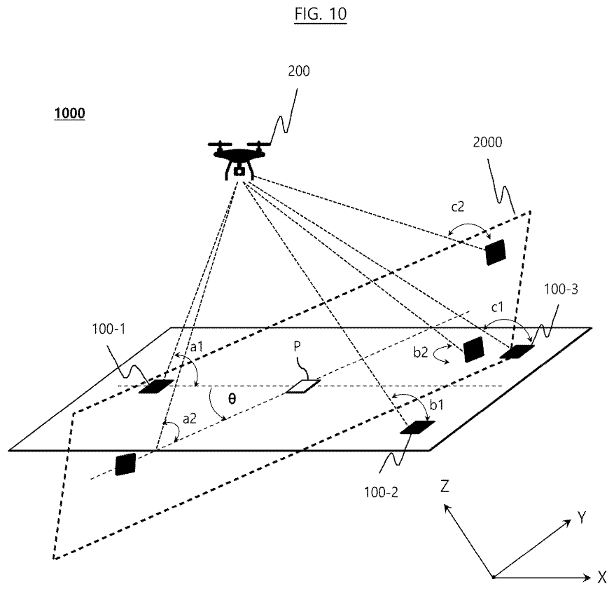

FIG. 10 is a diagram illustrating a system for guiding an aircraft to land on a landing pad that is three-dimensionally rotated according to another embodiment. In FIG. 10, the disposition of the second transmitter 100-2 in FIG. 9 has been changed. As illustrated, the first transmitter 100-1, the second transmitter 100-2, and the third transmitter 100-1 may be disposed to form a triangular configuration so as to surround the point of interest P without being disposed on the same line.

According to an embodiment, the transmitting unit 100 may be implemented by including four or more transmitters.

According to the aspects, an aircraft can safely and accurately land at a point of interest on a two-dimensionally moving landing pad.

An aircraft can safely and accurately land at a point of interest on a three-dimensionally moving landing pad.

The effects according to the present invention are not limited to the effects described above, and effects not mentioned may be clearly understood by a person having ordinary skill in the art to which the present invention pertains from this specification and the accompanying drawings.

Although the present invention has been described above through embodiments referring to the attached drawings, it is not limited thereto, and should be interpreted to encompass various modifications that may be obviously derived from these embodiments by those skilled in the art. The scope of the patent claims is intended to encompass such modifications.

Even though all components constituting the embodiments are described as being combined to operate as one, the present invention is not necessarily limited to these embodiments. That is, within the scope of the purpose of the present invention, one or more among all of the components may be selectively combined to operate as one.

What is claimed is:

1. An aircraft landing guidance system (1000) for landing an aircraft at a point of interest on a two-dimensionally moving landing pad, comprising:
a transmitting unit (100) that is disposed on a landing pad (2000) and continuously transmits a radio frequency signal; and
an aircraft (200) that receives the radio frequency signal,
wherein the transmitting unit (100) includes:
a first transmitter (100-1) that continuously transmits a first radio frequency signal; and
a second transmitter (100-2) that is disposed to be spaced apart from the first transmitter (100-1) and continuously transmits a second radio frequency signal, and
the aircraft (200) includes:
a receiving unit (210) that includes a first receiver (210-1) receiving the first radio frequency signal and a second receiver (210-2) receiving the second radio frequency signal;
an angle measuring unit (220) that measures a first angle that changes continuously over time between a transmission direction of the first radio frequency signal and a landing surface, and a second angle that changes continuously over time between a transmission direction of the second radio frequency signal and the landing surface, based on the transmission directions of the first radio frequency signal and the second radio frequency signal;
a landing pad movement calculating unit (230) that calculates a relative angular position change and relative speed of the landing pad based on the first angle and the second angle; and
a landing control unit (240) that guides and controls the aircraft to land at the point of interest based on the relative angular position change and relative speed of the landing pad.

2. The aircraft landing guidance system of claim 1, wherein the first transmitter (100-1), the second transmitter (100-2), and the point of interest (P) are disposed on the same line (L).

3. An aircraft landing guidance system for landing an aircraft at a point of interest on a three-dimensionally moving landing pad, comprising:
a transmitting unit (100) that is disposed on a landing pad (2000) and continuously transmits a radio frequency signal; and
an aircraft (200) that receives the radio frequency signal,
wherein the transmitting unit (100) includes:
a first transmitter (100-1) that continuously transmits a first radio frequency signal;
a second transmitter (100-2) that is disposed to be spaced apart from the first transmitter (100-1) and continuously transmits a second radio frequency signal; and
a third transmitter that is disposed to be spaced apart from the first transmitter and second transmitter and continuously transmits a third radio frequency signal,
the aircraft (200) includes:
a receiving unit (210) that includes a first receiver (210-1) receiving the first radio frequency signal, a second receiver (210-2) receiving the second radio frequency signal, and a third receiver (210-3) receiving the third radio frequency signal;
an angle measuring unit (220) that measures a first angle that changes continuously over time between a transmission direction of the first radio frequency signal and a landing surface, a second angle that changes continuously over time between a transmission direction of the second radio frequency signal and the landing surface, a third angle that changes continuously over time between a transmission direction of the third radio frequency signal and the landing surface, based on the transmission directions of the first radio frequency signal, the second radio frequency signal, and the third radio frequency signal;
a landing pad movement calculating unit (230) that calculates a relative angular position change and relative speed of the landing pad based on the first angle, the second angle, and the third angle; and
a landing control unit (240) that guides and controls the aircraft to land at the point of interest based on the relative angular position change and relative speed of the landing pad.

4. The aircraft landing guidance system of claim 3, wherein the first transmitter (100-1), the second transmitter (100-2), and the point of interest (P) are disposed on the same line (L).

5. The aircraft landing guidance system of claim 3, wherein the first transmitter (100-1), the second transmitter (100-2), and the third transmitter (100-3) are disposed to form a triangular configuration so as to surround the point of interest (P).
